(19) United States
(12) Patent Application Publication
(10) Pub. No.: US 2023/0410349 A1
(43) Pub. Date: Dec. 21, 2023

(54) Map-Free Visual Relocalization

(71) Applicant: Niantic International Technology Limited, Bristol (GB)

(72) Inventors: Eduardo Henrique Arnold, Coventry (GB); Jamie Michael Wynn, London (GB); Guillermo Garcia-Hernando, London (GB); Sara Alexandra Gomes Vicente, London (GB); Aron Monszpart, London (GB); Victor Adrian Prisacariu, Oxford (GB); Daniyar Turmukhambetov, London (GB); Eric Brachmann, Hanover (DE); Axel Barroso-Laguna, London (GB)

(21) Appl. No.: 18/212,141

(22) Filed: Jun. 20, 2023

Related U.S. Application Data
(60) Provisional application No. 63/354,097, filed on Jun. 21, 2022.

(51) Int. Cl. G06T 7/70; G06T 3/00; G06T 5/00; G06T 7/50; G06T 7/80; G06V 10/42; G06V 10/771

(52) U.S. Cl. CPC G06T 7/70; G06T 3/0093; G06T 5/002; G06T 7/50; G06T 7/80; G06V 10/42; G06V 10/771; G06T 2207/30244

(57) ABSTRACT

A method or a system for map-free visual relocalization of a device. The system obtains a reference image of an environment captured by a reference pose. The system also receives a query image taken by a camera of the device. The system determines a relative pose of the camera of the device relative to the reference camera based in part on the reference image and the query image. The system determines a pose of the query camera in the environment based on the reference pose and the relative pose.

### CROSS REFERENCE TO RELATED APPLICATIONS

This application claims priority to U.S. Provisional Patent Application Ser. No. 63/354,097, titled “Map-Free Visual Relocalization,” filed Jun. 21, 2022, which is incorporated herein by reference in its entirety.

### TECHNICAL FIELD

The subject matter described relates generally to relocalization, and, in particular, to relocalizing without the use of a pre-generated map of a location.

### BACKGROUND

A pose of a camera includes the position and orientation of the camera in a given environment. The process of determining a pose of a camera in a given environment may be referred to as visual relocalization. Visual relocalization plays a crucial role in various computer vision applications such as augmented reality, mixed reality, and robotics. Relocalization enables a camera system to understand its position relative to the surrounding world, allowing for precise interaction with the environment and accurate perception of objects.

However, visual relocalization has been a challenging task due to several factors. One of the primary difficulties arises from the inherent ambiguity of visual data. The images captured by a camera do not provide explicit information about the camera's pose or its location. Existing techniques may extract features from images captured by a camera and match them to a known 3-dimensional (3D) map to perform visual relocalization.

### SUMMARY

The present disclosure describes a map-free approach to visual relocalization. A single reference image of a scene is captured (e.g., by a device to be relocalized) and a pose of a device is determined based on the reference image and a query image captured by the device.

In some embodiments, the approach uses a relative pose regression (RPR) network. The RPR network receives a reference image and a query image. The reference image is captured by a reference camera at a first pose. The query image is captured by a camera of a device. Note, the first and second cameras may or may not be a same camera. The PRP network includes a Siamese network, a correlation network, a residual network, and a multiplayer perceptron network. The Siamese network receives the reference image to generate a first set of feature maps, and receives the query image to generate a second set of feature maps. The correlation network receives the first set of feature maps and the second set of feature maps to generate a set of global features. The residual network receives the set of global features as input to generate a global feature vector. The multiplayer perceptron network is configured to receive the global feature vector as input to generate a relative pose of the camera of the device, relative to the reference camera in the environment. The pose of the second camera can then be determined based on the relative pose and the reference pose.

In some embodiments, the approach generates a first depth map based on a reference image, generates a second depth map based on the query image, determines depth correspondences between the first depth map and the second depth map, and determines a pose of the camera of the device based in part on the depth correspondences between the first depth map and the second depth map.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example process of building a 3D scene and using the 3D scene to perform visual relocalization in accordance with some embodiments.

FIG. 2 illustrates an example process of generating a single reference image and performing visual relocalization using the single reference image in accordance with some embodiments.

FIG. 3A illustrates correspondences between a first depth map of a reference image and a second depth map of a query image in accordance with some embodiments.

FIG. 3B illustrates 2D-2D correspondences between a reference image and a query image in accordance with some embodiments.

FIG. 3C illustrates 3D-3D correspondences between a reference image and a query image in accordance with some embodiments.

FIG. 3D illustrates 2D-3D correspondences between a reference image and a query image in accordance with some embodiments.

FIG. 4A illustrates a first portion of the RPR network in accordance with some embodiments.

FIG. 4B illustrates a second portion of the RPR network that includes one multilayer perceptron (MLP) module in accordance with some embodiments.

FIG. 4C illustrates a second portion of the RPR network that includes two MLP modules in accordance with some embodiments.

FIGS. 5A-5F illustrate examples of training pairs sampled from training scenes in accordance with some embodiments.

FIG. 6A-6D illustrate examples of reference image and query images in accordance with some embodiments.

FIG. 7 is a flowchart for a method of map-free visual relocalization in accordance with some embodiments.

FIG. 8 is a flowchart for a method of determining a relative pose of a camera of a device relative to a reference camera using an RPR network in accordance with some embodiments.

FIG. 9 is a flowchart for a method of determining a relative pose of a camera of a device relative to a reference camera using feature matching in accordance with some embodiments.

FIG. 10 depicts a representation of a virtual world having a geography that parallels the real world in accordance with some embodiments

FIG. 11 depicts an exemplary game interface of a parallel reality game in accordance with some embodiments.

FIG. 12 is a block diagram of a networked computing environment suitable for providing map-free visual relocalization in accordance with some embodiments.

FIG. 13 illustrates an example computer system suitable for use in the networked computing environment of FIG. 10 in accordance with some embodiments.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where device relocalization is desirable. In addition, the inherent flexibility of computer-based systems allows for a great variety of possible configurations, combinations, and divisions of tasks and functionality between and among the components of the system.

Determining the location and orientation (collectively “pose”) of a camera that captures an image unlocks a wide array of options for providing functionality and content to users. The process of determining a pose of a camera may be referred to as visual relocalization. Visual relocalization enables a camera system to understand its position relative to the surrounding world, allowing for precise interaction with the environment and accurate perception of objects.

A 2D photograph includes an idea of the 3D world. One can imagine what the depicted place looks like, and where one, looking through the lens, would be standing relative to that place. Visual relocalization mimics the human capability to estimate a camera's position and orientation from a single query image. Existing approaches to visual relocalization often compare one or more images captured by a camera to a pre-existing 3D map of the scene to match the features shown in the image to the map.

Visual relocalization is a task that enables exciting applications in augmented reality (AR) and/or robotic navigation. State-of-the-art relocalization methods may surpass human rule-of-thumb estimates by a noticeable margin, allowing centimeter accurate prediction of a camera's pose. But this capability comes with a price: each scene is carefully pre-scanned and reconstructed. First, images are gathered from hundreds of distinct viewpoints, ideally spanning different times of day and even seasons. Then, the 3D orientation and position of these images are estimated, e.g., by running structure-from-motion (SfM) or simultaneous-localization-and-mapping (SLAM) software. Oftentimes, accurate multi-camera calibration, alignment against LiDAR scans, high-definition maps, and/or inertial sensor measurements are used to recover poses in metric units. Finally, images and their camera poses are fed to a relocalization pipeline.

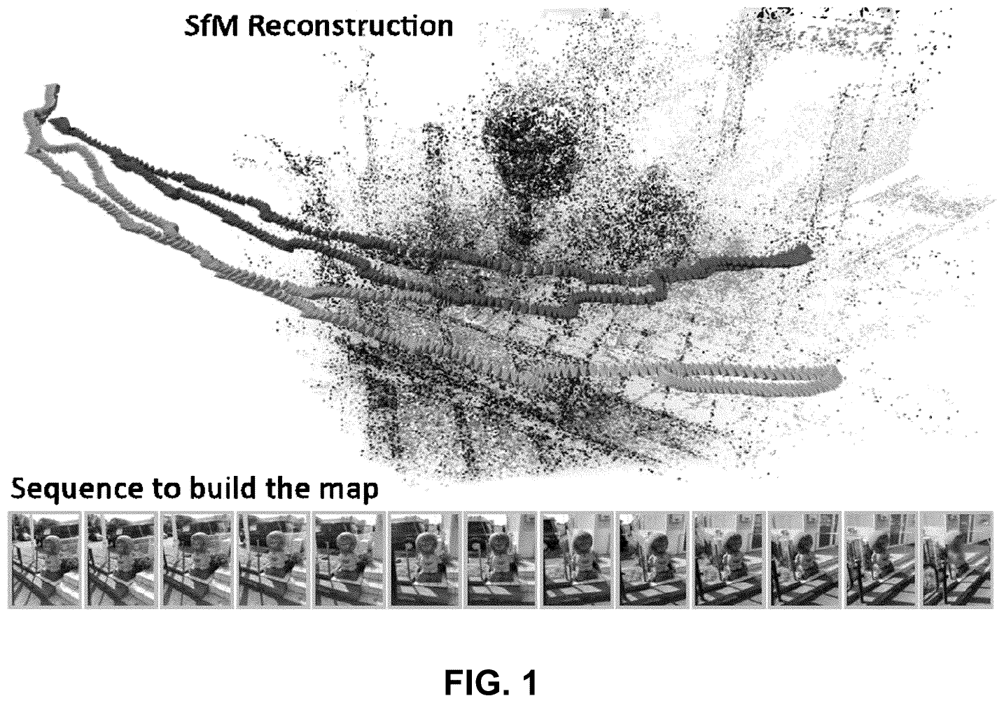

FIG. 1 illustrates an example process of building a 3D scene and using the 3D scene to perform visual relocalization in accordance with some embodiments. For traditional structure-based systems, the final scene representation includes a point cloud triangulated from feature correspondences, and associated feature descriptors. The requirement for systematic pre-scanning and mapping restricts how visual relocalization can be used. For example, AR immersion might break if a user has to record an entire image sequence of an unseen environment first, gathering sufficient parallax by walking sideways, all in a potentially busy public space. Furthermore, depending on the relocalization system, the user then has to wait minutes or hours until the scene representation is built.

To solve the above-described problem, embodiments described herein introduce methods of map-free relocalization, in which mapping requirement is relaxed to the point where a single reference image is enough to relocalize new queries in a metric coordinate system. Map-free relocalization described herein enables instant or near-instant AR capabilities at new locations.

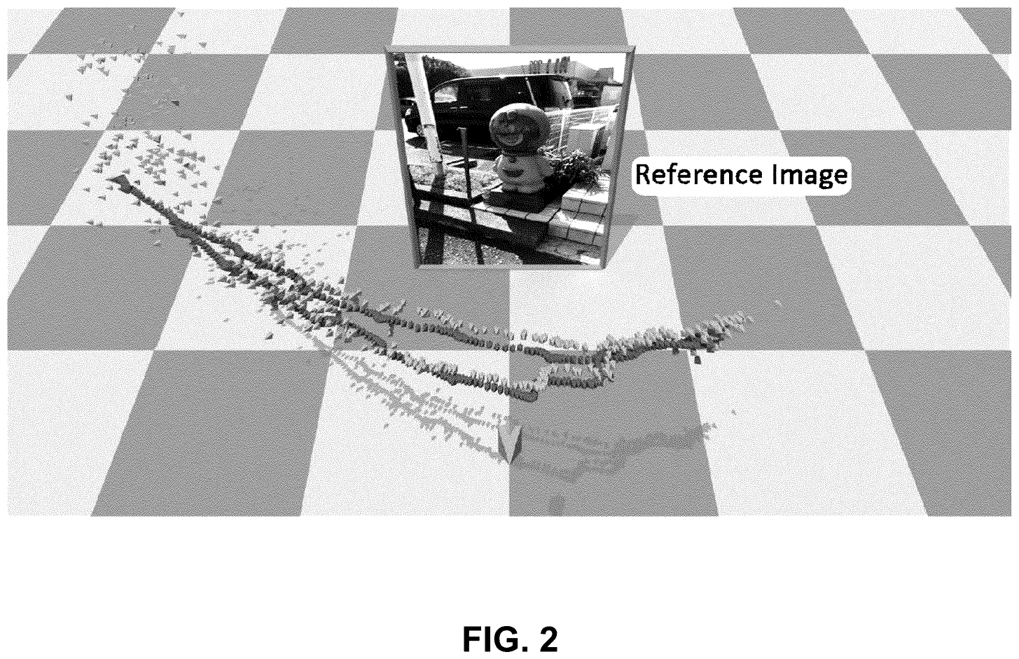

FIG. 2 illustrates an example process of generating a single reference image and performing visual relocalization using the single reference image. For example, user A points their camera at a structure, and takes a photo. Any user B can instantly relocalize with respect to user A. The map-free relocalization constitutes a systematic, task-oriented benchmark for two-frame relative pose estimation, namely between the reference image and a query image.

In particular, two sets of methods are described herein to provide baseline results: (1) feature matching combined with single-image depth prediction (hereinafter also referred to as “feature matching method”), and (2) relative pose regression (hereinafter also referred to as “relative pose regression method”).

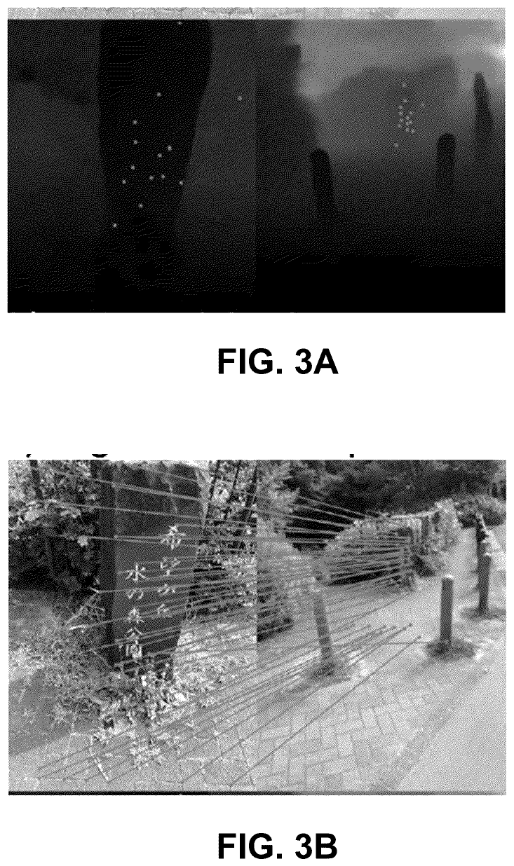

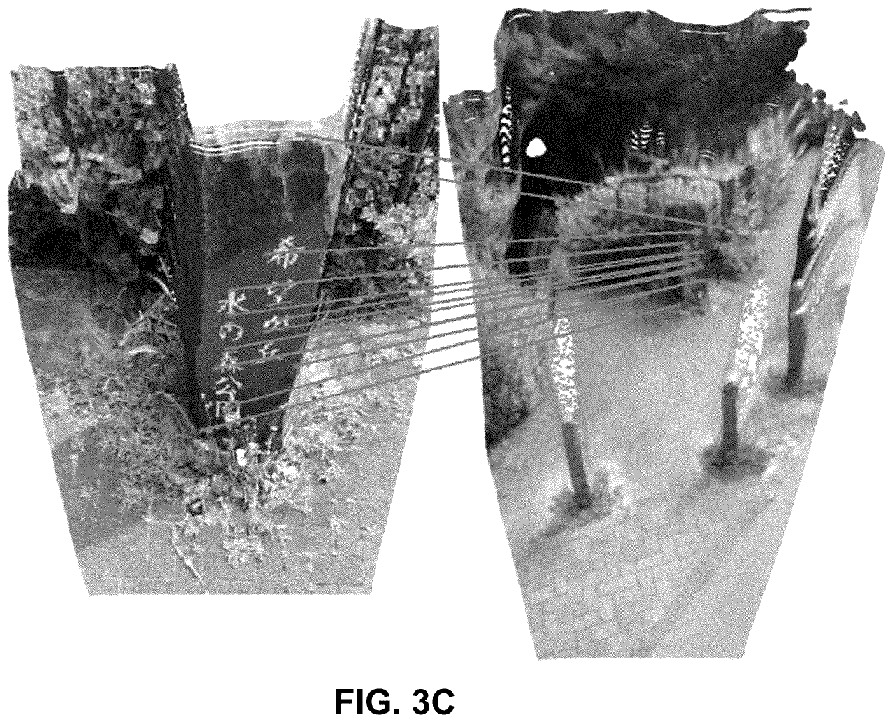

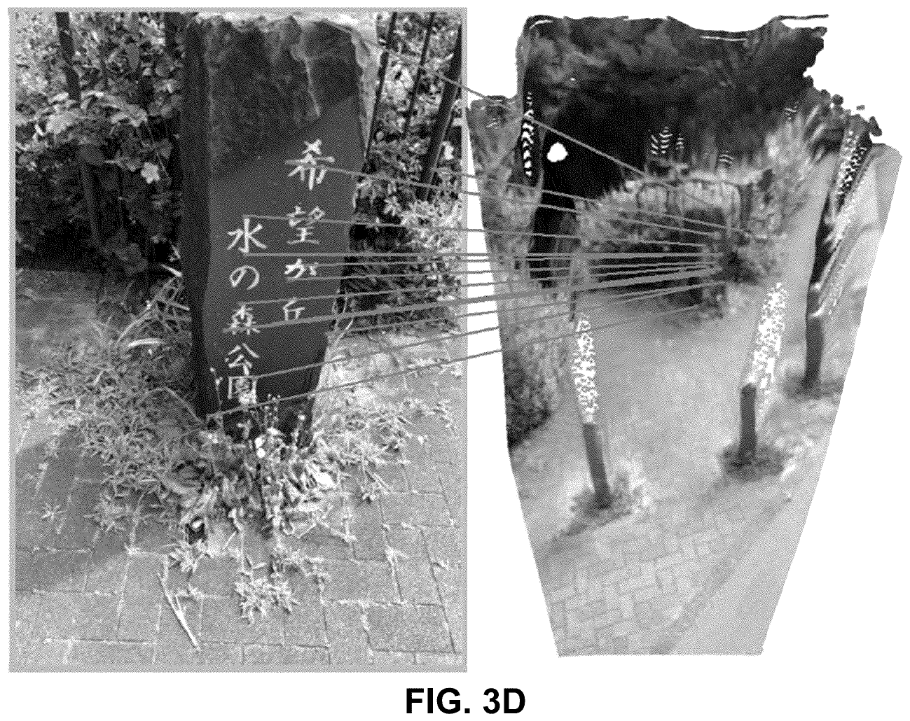

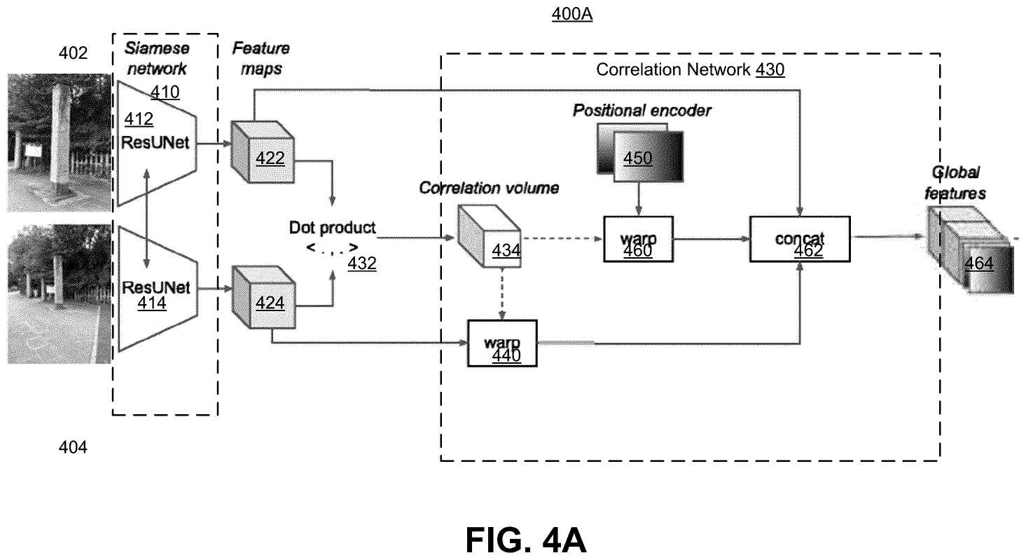

Applying these methods, a single reference image can be enough to enable visual relocalization. A dataset that provides reference and query images of over 600 places of interest worldwide, annotated with ground truth poses, is generated. The dataset includes challenges such as changing conditions, stark viewpoint changes, high variability across places, and queries with low to no visual overlap with the reference image. Baseline results for map-free relocalization are provided using relative pose regression methods, and feature matching on top of single image-depth prediction. The two sets of methods are further described below with respect to FIGS. 3-8.

### Feature Matching Method

The feature matching methods include estimating a relative pose from 2D correspondences up to scale via an Essential matrix. SIFT is considered as a traditional baseline as well as more recent learning-based matchers such as SuperPoint+SuperGlue and LoFTR. To recover the missing scale, monocular depth estimation may be utilized. For indoors, DPT fine-tuned on the NYUv2 dataset and PlaneRCNN, which was trained on ScanNet, may be used. For out-doors, DPT fine-tuned on KITTI may be used.

In some embodiments, single-image depth prediction may be implemented in pose estimation problems. Predicted depth maps may be used to rectify planar surfaces before local feature computation for improved relative pose estimation under large viewpoint changes. Depth prediction may be incorporated into monocular SLAM and Visual Odometry pipelines to combat scale drift and improve camera pose estimation. Predicted depths were used as a soft constraint in multi-image problem, while embodiments described herein use depth estimates to scale relative pose between two images.

In some embodiments, deep learning is implemented for single-image depth estimation. There are two versions of the problem: relative and absolute depth prediction. Relative, also called scaleless, depth prediction aims at estimating depth maps up to an un-known linear or affine transformation, and can use scaleless training data such as SfM reconstructions, uncalibrated stereo footage or monocular videos. Absolute depth prediction methods aim to predict depth in meters by training or fine-tuning on datasets that have absolute metric depth such as the KITTI, NYUv2, and ScanNet datasets.

Given estimated depths, scaled relative poses can be computed in the following variants: (1) 2D-2D correspondences, (2) 2D-3D correspondences, and (3) 3D-3D correspondences.

In some embodiments, 2D-2D correspondences are computed, and the relative pose is determined based in part on the 2D-2D correspondences. Computing 2D-2D correspondences includes computing Essential matrix using a 5-point solver with MAGSAC++ and decomposing it into a rotation and a unitary translation vector. MAGSAC inlier correspondences are back projected to 3D using the estimated depth. Each 3D-3D correspondence provides one scale estimate for the translation vector, and the scale estimate with maximum consensus across correspondences is selected. FIG. 3A visualizes inlier correspondences for the robust RANSAC-based essential matrix computation in green and outlier correspondences in red. FIG. 3B illustrates a 2D-2D correspondence using a feature matching method.

In some embodiments, 2D-3D correspondences are computed, and the relative pose is determined based in part on the 2D-3D correspondences. Computing 2D-3D correspondences includes using estimated depth to project one of the two images to 3D to generate 2D-3D correspondences. This allows using of a PnP solver to recover a metric pose. In some embodiments, PnP with RANSAC is used, and the final estimate is refined using all inliers. 2D features from the reference image and 3D points from the query image are used in this method. FIG. 3C illustrates depth maps coupled with the 2D-2D correspondences to obtain 3D-3D correspondences.

In some embodiments, 3D-3D correspondences are computed, and the relative pose is determined based in part on the 3D-3D correspondences. Computing 3D-3D correspondences includes using estimated depth to back-project both images to 3D, giving 3D-3D correspondences. In some embodiments, the relative pose is computed using Orthogonal Procrustes inside a RANSAC loop. Optionally, we can refine the relative pose using ICP on the full 3D point clouds. FIG. 3D illustrates depth maps coupled with 2D-2D correspondences to obtain 2D-3D correspondences.

In some embodiments, rotation and translation may be modeled jointly, and the method predicting 3D-3D correspondences for predefined key points of specific object classes may be implemented. The transformation that aligns these two sets of point triplets are computed using Procrustes, which gives the relative rotation and translation between the two images. The models are trained end-to-end until convergence by supervising the output pose with the ground truth relative pose. Different loss functions and weighting between rotation and translation losses may be used.

### Relative Post Regression Method

In some embodiments, relocalization by relative pose estimation may be achieved via a relative pose regression method. In some embodiments, neural networks may be trained to regress metric relative poses directly from two images. Thus far, such system have been evaluated on standard relocalization benchmarks where structure-based methods rule supreme, to the extent where the accuracy of the ground truth is challenged. The principles described herein enable several new capabilities that traditional structure-based methods cannot provide. Based on a single photo, a scene cannot be reconstructed by SfM or SLAM. While feature matching still allows to estimate the relative pose between two images, the reference and the query, there is no notion of absolute scale. To recover a metric estimate, some heuristic or world knowledge has to be applied to resolve the scale ambiguity which may be a problem. Pose regression networks, that predict metric poses by means of supervised learning, are suitable for map-free relocalization. It is proven that a combination of deep feature matching and deep single-image depth prediction can achieve a high relative pose accuracy.

To simulate research in map-free relocalization, a new benchmark and dataset are presented. In some embodiments, images of 655 places of interest worldwide are gathered, where each place can be represented well by a single reference image. All frames in each place of interest have metric ground truth poses. There are 530,032 frames for training, 37,521 query frames across 65 places for validation, and 14,990 query frames (subsampled from 74,790 frames) across 130 places in the test set. A public validation set is provided while keeping the test ground truth private. The public validation set is accessed through an online evaluation service. This dataset can serve as a test bed for advances in relative pose estimation and associated sub-problems such as wide-baseline feature matching, robust estimation, and single-image depth prediction.

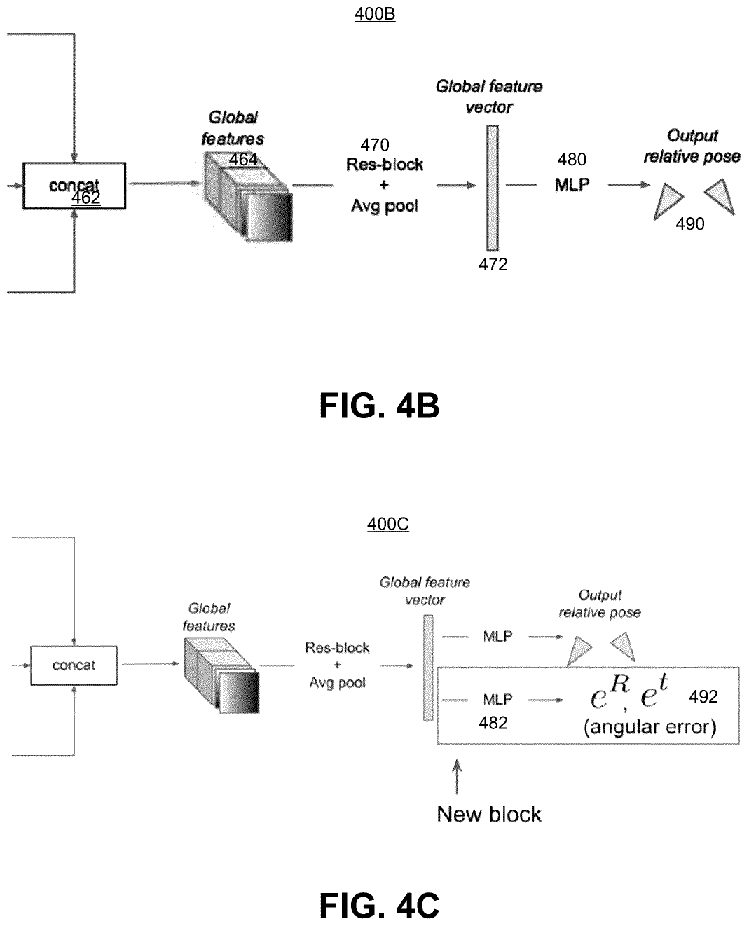

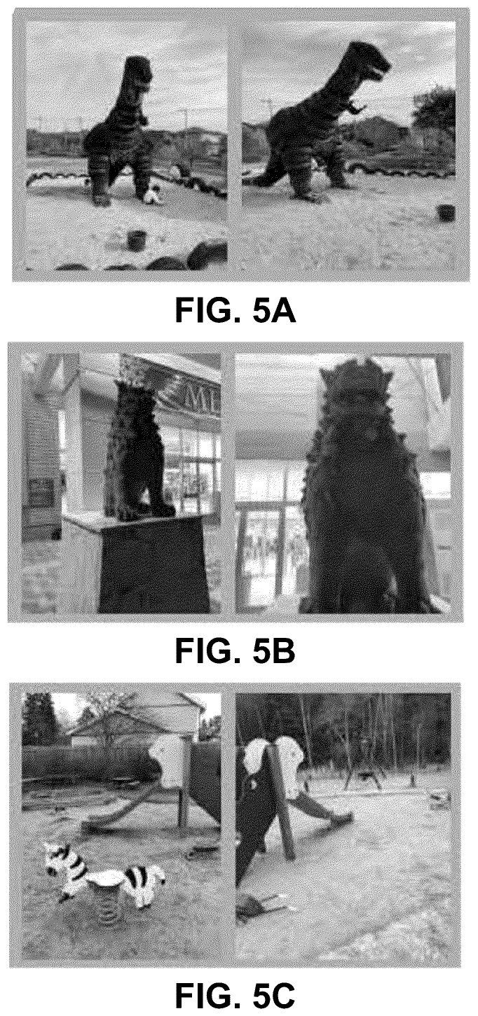

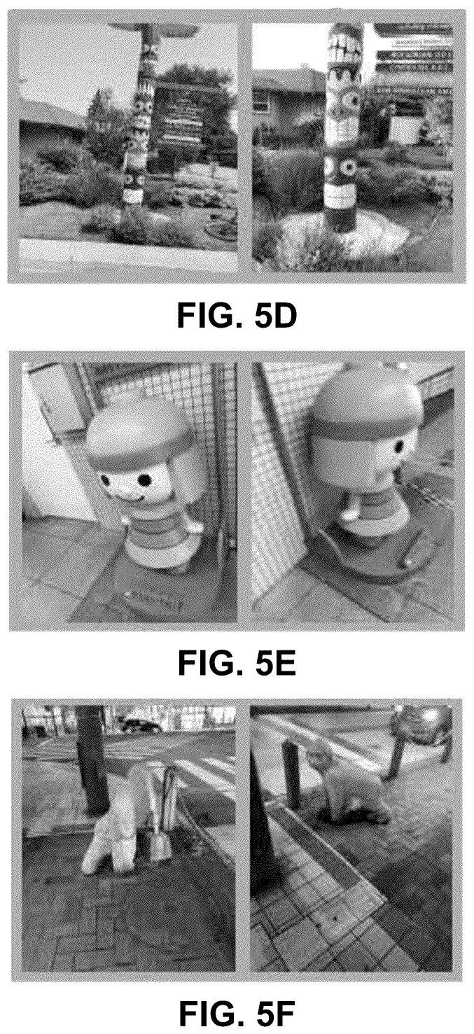

Relative pose regression (RPR) method described herein implements an RPR networks configured to learn to predict metric relative poses in a forward pass. FIGS. 4A-4C illustrate example architectures of RPR networks. FIG. 4A illustrates a first portion of the RPR network 400A that includes a Siamese network 410 and a correlation network 430. The Siamese network 410 includes two convolutional networks 412 and 414. Each of the two convolutional networks 412 and 414 is configured to receive a first image 402 or a second image 404. In some embodiments, each of the convolutional networks 412 and 414 is a deep residual UNet. The first image 402 or second image 404 is a reference image or a query image. The network 412 receives the first image 402 as input to generate a first set of feature maps 422, and the network 414 receives the second image 404 as input to generate a second set of feature maps 424.

The correlation network 430 receives the first set of feature maps 422 and the second set of feature maps 424 to output a set of global features 464. The correlation network 430 includes a dot product module 432, a first warp module 440, a second warp module 460, a positional encoder 450, and a concatenate module 462. The dot product module combines the first set of feature maps 422 and the second set of feature maps 424 to generate a correlation volume 434. The positional encoder 450 is configured to encode positions of cameras into a sequence of a grid of coordinates so that each position is assigned a unique representation.

In some embodiments, the correlation volume 434 is a 4D correlation volume computed to mimic soft feature matching. The correlation volume 434 is then used to warp the second set of feature maps 424 and a regular grid of coordinates (generated by the positional encoder 450). As illustrated, the first warp module 440 is configured to warp the second set of feature maps 424 using the correlation volume 434. The second warp module 460 is configured to warp positional data generated by the positional encoder 450 using the correlation volume 434. The output of the first warp module 440, the output of the second warp module 460, and the output of positional encoder 450 are then input to the concatenate module 462 to be concatenated into global features 464.

FIG. 4B illustrates a second portion of the RPR network 400B in accordance with one embodiment. The concatenate module 462 receives the outputs of the first warp module 440, the second warp module 460, and the positional encoder 450 to output global features 464. The RPR network 400B also includes a residual and average pool module 470 configured to receive the global features 464 as input to output a global feature vector 472. The RPR network 400B also includes a multilayer perceptron (MLP) module 480 configured to receive the global feature vector 472 as input to output relative pose between the first image 402 and the second image 404.

The RPR networks 400A and 400B in FIGS. 4A and 4B are configured to determine the relative pose between two images without relying on the explicit estimation of 2D correspondences. However, one limitation of the RPR networks shown in FIG. 4B is that they do not provide a confidence level in their predicted poses. As such, even though the relative poses are estimated, there is no mechanism that can hint at whether such poses are reliable or not.

As a reference, 2D correspondence-based methods, e.g., SIFT, use the number of inlier correspondences to measure the confidence of their estimation. However, since RPR networks 400B do not rely on correspondences, such inlier heuristics are not fit for RPR.

To solve the above described problem, in some embodiments, the RPR network may further include a second MLP module (in parallel with the first MPL module 480) to determine an angular error. FIG. 4C illustrates a second portion of the RPR network 400C that includes a second MLP module 482 in accordance with some embodiments. The MLP module 482 is configured to receive the global feature vector 472 as input to output an angular error 492. The angular error 492 indicates whether the relative poses can be trusted.

Specifically, an annular translation and rotation errors associated with the predicted relative pose are regressed. The ground truth errors for training are computed with respect to the ground truth relative pose during training. Such errors can be used as a confidence value, where the most confidence estimation corresponds to the estimation with the lowest prediction error. The second MLP module 482 can be trained with a soft clamping of the ground truth error as well as the network prediction, such as using Equation (1) below:

[symbol]

=|g(eᵢ^{-t})−g(eᵢ^{t})|+|g(eᵢ^{-R})−g(eᵢ^{R})| Equation (1)

where g(x) refers to a soft clamping function.

Experiments show that when the confidence estimations are added, results improve.

As described above, the PRP network uses a reference image and a query image to predict a pose of the query image with respect to the reference image pose. Since both images are available, a pose of the reference image with respect to the query image may also be computed, inverting the predicted pose. The two pose estimates are not guaranteed to be consistent. In some embodiments, rotation, and/or translation averaging of two relative pose predictions may be used to achieve image-order equivariant relative pose estimation, further improving the prediction results.

Given a pair of images (A, B), relative pose regression network f_{θ}(A, B) aims to predict the relative pose [symbol] :

f_{θ}(A,B)= [symbol] Equation (2)

The relative pose [symbol] includes a rotation (e.g., parameterized as a 3×3 matrix) and translation, typically parametrized as a 4×4 matrix:

$${P}_{\vec{AB}} = [ \begin{matrix}{R}_{\vec{AB}} & {t}_{\vec{AB}} \\ 0 & 1\end{matrix} ] \qquad Equation ( 3 )$$

where [symbol] is a 3×3 rotation matrix and [symbol] is a 3×1 translation vector.

If the order of the images is switched to (B, Q), the prediction of f_{θ}(B,A) would aim to predict the relative pose [symbol] . If both predictions are perfect, then the predicted poses should be consistent with each other, i.e.:

[symbol]

= [symbol] and [symbol] = [symbol] Equation (4)

However, in practice, the network f_{θ}( ) is not perfect. Thus, it can produce two inconsistent predictions:

| [symbol] − [symbol] |>0 Equation (5)

or

[symbol]

≠I Equation (6)

where I is identity.

In some embodiments, the two independent pose predictions can be combined via pose averaging function g( ):

g(f_{θ}(A,B),f_{θ}(B,A))=g( [symbol] )= [symbol] Equation (7)

As a result, the average g(fθ(A,B), f_{θ}(B,A)) would provide pose [symbol] and average μ(f_{θ}(B,A), f_{θ}(A,B)) would provide pose [symbol] . Even if independent pose predictions [symbol] and [symbol] are inconsistent, the averaged poses [symbol] and [symbol] would be consistent:

[symbol]

= [symbol] and [symbol] = [symbol] Equation (8)

In some embodiments, rotation averaging is implemented. Rotation matrix [symbol] can be converted to a [symbol] quaternion and vice versa. The rotations can be averaged using

### Spherical Linear Interpolation.

Hence, the averaged rotation can be computed as:

[symbol]

=Slerp( [symbol] ,0.5) Equation (9)
Where [symbol] is the conjugate of [symbol] and is equivalent to [symbol] . Thus, the average rotation is consistent:

[symbol]

=I Equation (10)

In some embodiments, translation averaging is implemented. Translation vector corresponds to the position of one camera in another camera's coordinate frame. So the translation needs to also incorporate the rotation. One approach is to compute the averaged translation as:

$${\overline{t}}_{\vec{AB}} = \frac{1}{2} ( {t}_{\vec{AB}} + ( - {R}_{\vec{BA}}^{T} {t}_{\vec{BA}} ) ) \qquad Equation ( 11 )$$

The averaged pose would be

$${T}_{\vec{AB}} = [ \begin{matrix}{\overline{R}}_{\vec{AB}} & {\overline{t}}_{\vec{AB}} \\ 0 & 1\end{matrix} ] \qquad Equation ( 12 )$$

In some embodiments, weighted pose averaging is implemented. Weight pose averaging allows the relative pose regression network to also predict a scalar “confidence” value c® that the network associates with the accuracy of the predicted rotation and scalar confidence c^{(t)} that the network associate with the accuracy of the predicted translation. So, in addition to the relative pose [symbol] , the network predicts confidences [symbol] and [symbol] for image pair (A,B). Similarly, the network can predict [symbol] and [symbol] for image pair (B, A).

Thus, the confidences can be converted into weights for weighted rotation averaging:

[symbol]

=softmax ( [symbol] ) Equation (13)

Such that [symbol] + [symbol] =1.

Similarily for translation weights [symbol] and [symbol] .

Consequently, the weighted rotation averages would be:

[symbol]

=Slerp( [symbol] ) Equation (14)

And

[symbol]

=Slerp( [symbol] ) Equation (15)

Finally, the weighted translation average would be:

[symbol]

= [symbol] + [symbol] ( [symbol] +(− [symbol] )) Equation (16)

And the averaged pose would be

$${T}_{\vec{AB}} = [ \begin{matrix}{\overline{R}}_{\vec{AB}} & {\overline{t}}_{\vec{AB}} \\ 0 & 1\end{matrix} ] \qquad Equation ( 17 )$$

During network training, for every image pair A and B, independent predictions P and P and poses T and T can be supervised. The loss for each pose can be a combination of rotation and translation errors.

Experiments show an evaluation of RPR models that were trained on Map-free dataset compared to the baseline (that was trained by supervising PAB only), where the two approaches that use averaging achieve superior results. In particular, average median errors are significantly reduced, and area under the curve for “correct” poses and “correct” virtual correspondence reprojections is increased.

In some embodiments, the RPR networks parameterize rotations as quaternions (denoted as R(q)). A 6D parameterization of rotation may avoid discontinuities of other representations: the network predicts two 3D vectors and creates an orthogonal basis through a partial Gram-Schmidt process (denoted as R(6D)). For rotation, Discrete Euler angles may be applied, denoted as R (α, β, γ). A first set of (e.g., 360) discrete values for yaw and roll may be used, and a second set of (e.g., 180) discrete values for the pitch angle may be used. For the translation vector, three parameterization options may be implemented: (1) predicting the scaled translation (denoted as t), (2) predicting a scale and unitary translation separately (denoted as s·\hat{t}), and (3) scale and discretized unitary translation. For the latter, translation in spherical coordinates, denoted as ϕ,θ, with quantized bins of 1 deg as well as a 1D scale (denoted as) s·\hat{t}(ϕ,θ)) may be predicted.

In some embodiments, relative pose regression may be applied in scenarios that are challenging for correspondence-based approaches. Some approaches focus on estimating the relative rotation between two images in extreme cases, including when there is no overlap between the two images. Similarly, the method in such approaches may estimate scaleless relative pose for pairs of images with very low overlap. The embodiments described herein create baselines and output parameterization.

In some embodiments, intrinsics of cameras that took the reference image and the query image are also obtained and used to determine the pose of the query image. Assuming intrinsics of both images are known, as they are generally reported by modern devices. The absolute pose of a query image Q is parameterized by R SO(3), t R3, which maps a world point y to point x in the camera's local coordinate system as x=Ry+t. Assuming the global coordinate system is anchored to the reference image, the problem of estimating the absolute pose of the query becomes one of estimating a scaled relative pose between two images.

### Map-Free Relocalization Dataset

One of the most commonly used datasets for visual relocalization is 7Scenes, containing seven small rooms scanned with KinectFusion. 12Scenes provides a few more, and slightly larger environments, while RIO10 provides 10 scenes focusing on condition changes between mapping and query images. For outdoor relocalization, Cambridge Landmarks and Aachen Day-Night, both contain large SfM reconstructions, are popular choices.

However, such existing datasets are generally not suitable to benchmark map-free relocalization. Firstly, their scenes are not well captured by a single image which holds true for both indoor rooms and large-scale outdoor reconstructions. Secondly, the variability across scenes is extremely limited, with 1-12 distinct scenes in each single dataset.

Thus, embodiments described herein construct a new dataset of multiple small places of interest, such as sculptures, murals, and fountains, collected worldwide. In some embodiments, each of the multiple places corresponds to a reference image to serve as a relocalization anchor, and dozens of query images with known, metric camera poses. The dataset includes images taken with changing conditions, stark viewpoint changes, high variability across places, and queries with low to no visual overlap with the reference image.

In some embodiments, the dataset captures 655 distinct places of interest outdoors with 130 reserved for testing alone. Each of the 655 scenes contains a small “place of interest” such as a sculpture, sign, mural, etc., such that the place can be well-captured by a single image.

The scenes are split into 460 training scenes, 65 validation scenes, and 130 test scenes. Each raining scene has two sequences of images, corresponding to two different scans of the scene. Absolute pose of each training image is provided, allowing determination of the relative pose between any pair of training image. Overlap scores between any pair of images (intra- and inter-sequence) may also be provided, which can be used to sample training pairs. For validation and test scenes, a single reference image obtained from one scan and a sequence of query images and absolute poses from a different scan are provided. Camera intrinsic are provided for all images in the dataset.

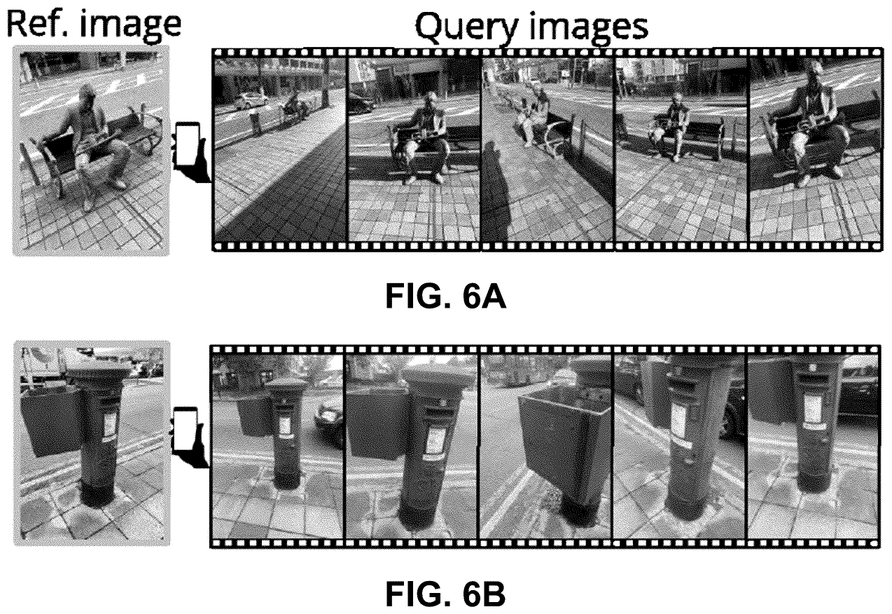

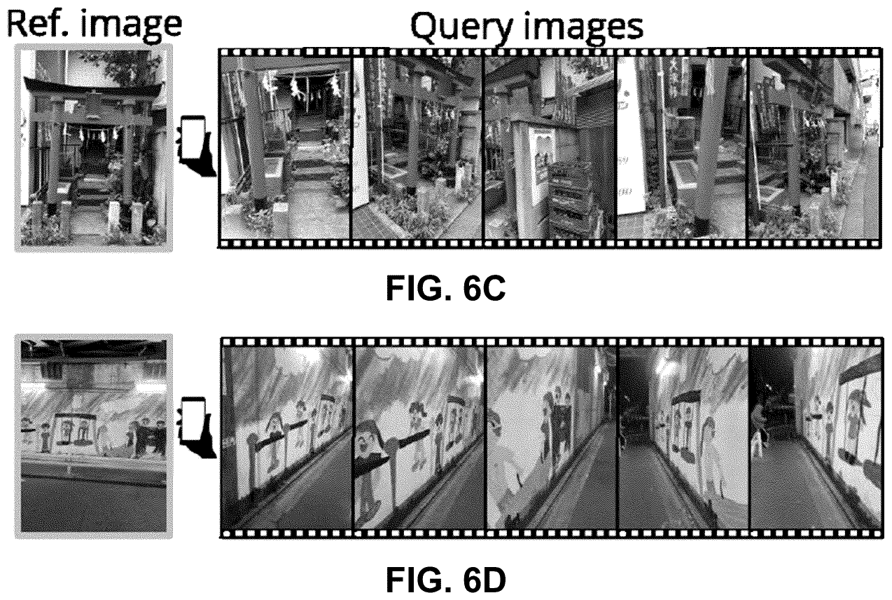

FIGS. 5A-5F illustrate examples of training pairs sampled from training scenes. FIG. 6A-6D illustrate examples of reference frame and query images. Query sequences may be sampled at relative temporal frames: 0%, 25%, 50%, 75%, and 100% of the sequence duration.

In some embodiments, the dataset may be crowd-sourced from members of the public who scanned places of interest using their mobile phones. Each scan contains video frames, intrinsics and (metric) poses estimated by ARKit (iOS) or ARCore (android) frameworks and respective underlying implementations of Visual-Inertial Odometry and Visual-Inertial SLAM. Automatic anonymization software is used to detect and blur faces and car license plates in frames. Scans may be registered with each other using COLMAP.

In some embodiments, the scans may first be bundle adjusted individually by initializing from raw ARKit/ARCore poses. Then, the two 3D reconstructions of each scan would (robustly) align to the raw ARKit/ARCore poses. Finally, the 3D reconstruction is rescaled using the average scale factor of the two scans. Poses obtained via SfM constitute only a pseudo ground truth, and estimating their uncertainty bounds has recently been identified as an open problem in relocalization research. However, given the challenging nature of map-free relocalization, much coarser error threshold than standard relocalization works. Thus, the results are less susceptible to inaccuracies in SfM pose optimization.

The places of interest in the dataset may be drawn from a wide variety of locations around the world and a large population of people were requested to upload a scan. This leads to a number of interesting challenges, such as a variations in the capture time, illumination, weather, season, and cameras, and even the geometry of the scene; and variations in the amount of overlap between the scans.

### Evaluation Protocol

Evaluation protocol includes rotation, translation and reprojection errors computed using ground truth and estimated relative poses that are predicted for each query and reference image pair. Given estimated (R, t) and ground truth (R_{gt}, t_{gt}) poses, rotation error is computed as an angle (in degrees) between predicted and ground truth rotations, [symbol] (R, R_{gt}). A translation error is computed as the Euclidean distance between predicted c and ground truth c camera centers in world coordinate space, where c=−R^{T}t.

A reprojection error provides an intuitive measure of AR content misalignment. Similar to the Dense Correspondence Reprojection Error (DCRE) which measures the average Euclidean distance between corresponding original pixel positions and reprojected pixel positions obtained via back-projecting depth maps. As the dataset does not contain depth maps, it is not possible to compute the DCRE. Thus, a Virtual Correspondence Reprojection Error (VCRE): ground truth and estimated transformations are used to project virtual 3D points, located in the query camera's local coordinate system. VCRE is the average Euclidean distance of the reprojection errors:

$$VCRE = \frac{1}{\vert V \vert} {\sum }_{v ∈ V} {‖ π ( v ) - π ( {TT}_{gt}^{- 1} v ‖}_{2} with T = [ R \vert t ] \qquad Equation ( 18 )$$

where π is the image projection function, and [symbol] is a set of 3D points in camera space representing virtual objects.

For convenience of notation, it is assumed that all entities are in homogeneous coordinates. To simulate an arbitrary placement of AR content, a 3D grid of points for V (4 in height, 7 in width, 7 in depth) with equal spacing of 30 cm and with an offset of 1.8 m along the camera axis. It is found that DCRE and VCRE are well-aligned. In standard relocalization, best methods achieve a DCRE below a few pixels. However, map-free relocalization is a challenge, relying on learned heuristics to resolve the scale ambiguity. Thus, more generous VCR thresholds are applied for accepting a pose, namely 5% and 10% of the image diagonal. While a 10% offset means a noticeable displacement of AR content, it can still yield an acceptable AR experience.

The evaluation protocol also considers the confidence of pose estimates. Confidence enables the relocalization system to flag and potentially reject unreliable predictions. This is a crucial capability for a map-free relocalization system to be practical since a user might record query images without any visual overlap with the reference frame. A confidence can be estimated as the number of inlier correspondences in feature matching baselines. Given a confidence threshold, the recall can be computed as the ratio of query images with confidence greater-or-equal to the threshold, i.e., the ratio of non-rejected samples. Similarly, the precision can be computed as the ratio of non-rejected query images for which the pose error (translation, rotation) or the reprojection error is acceptable (below a given threshold). Each confidence threshold provides a different trade-off between precision and recall. The average precision (AP) can also be computed as the weighted sum of precision for all recall levels. Models that are incapable of estimating a confidence have a flat Precision-Recall (PR) curve.

Experiments show that the baselines described herein are competitive with the state of the art when a large number of mapping images is available. The experiments also show that as the number of mapping images reduces, map-free suitable methods degrade more gracefully than traditional approaches.

### Example Methods of Map-Free Visual Relocalization

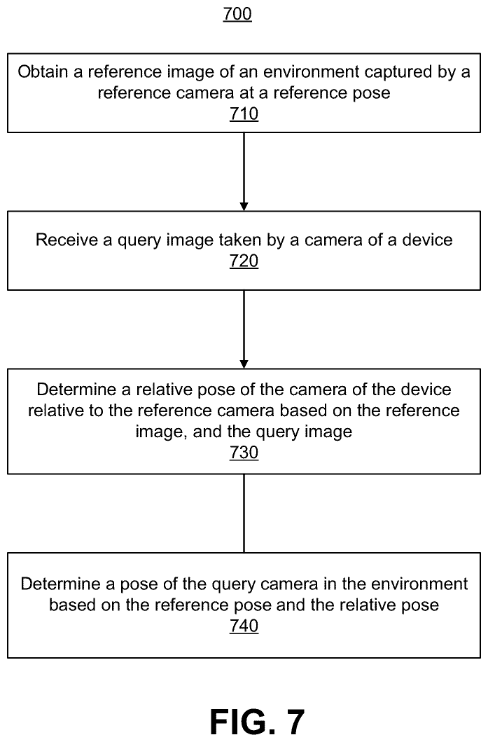

FIG. 7 is a flowchart for a method of map-free visual relocalization, in accordance with some embodiments. Alterative embodiments may include more, fewer, or different steps from those illustrated in FIG. 7, and the steps may be performed in a different order from that illustrated in FIG. 7. These steps may be performed by a computer system, an online system, or a client device, such as a mobile phone, a camera, etc.

A system obtains 710 a reference image of an environment captured by a reference camera at a reference pose. For example, the reference image is obtained from a dataset including multiple small places of interest, such as such as sculptures, murals, and fountains, collected worldwide. In some embodiments, each of the multiple places corresponds to a reference image to serve as a relocalization anchor, and dozens of query images with known, metric camera poses. The dataset includes images taken with changing conditions, stark viewpoint changes, high variability across places, and queries with low to no visual overlap with the reference image.

The system receives 720 a query image taken by a camera of a user. For example, the user may use a mobile device to take a query image in the environment. The system determines 730 a relative pose of the camera of the user relative to the reference camera based on the reference image and the query image. The system also determines 740 a pose of the query camera in the environment based on the reference pose and the relative pose.

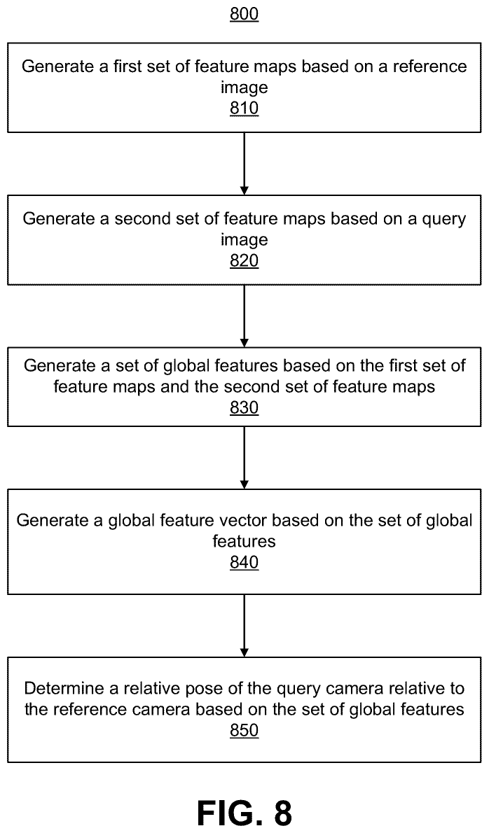

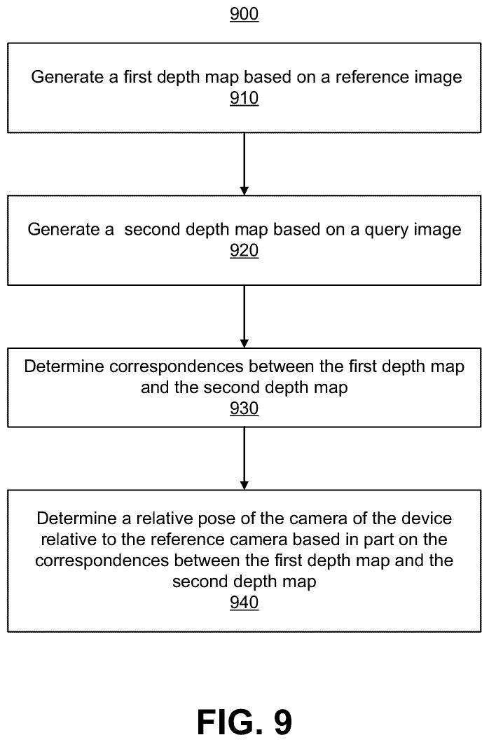

Various methods may be implemented to determine a relative pose of the camera of the user relative to the reference camera. One set of methods uses a relative pose regression (RPR) network to determine the relative pose, which is further described below with respect to FIG. 8. Another set of methods uses feature matching to determine the relative pose, which is further described below with respect to FIG. 9.

FIG. 8 is a flowchart for a method 800 of determining a relative pose of a camera of a user relative to a reference camera using a RPR network. Alterative embodiments may include more, fewer, or different steps from those illustrated in FIG. 8, and the steps may be performed in a different order from that illustrated in FIG. 8. These steps may be performed by a computer system, an online system, or a client device, such as a mobile phone, a camera, etc.

The RPR network may correspond to the RPR network illustrated in FIGS. 4A-4C. The RPR network generates 810 a first set of feature maps based on a reference image taken by a reference camera. The RPR network generates 820 a second set of feature maps based on a query image taken by a camera of a user. In some embodiments, the RPR network includes a Siamese network (e.g., Siamese network 410). The Siamese network include a first neural network (e.g., residual UNet 412) and a second neural network (e.g., residual UNet 414). The first neural network receives the reference image to generate the first set of feature maps (e.g., feature maps 422), and the second neural network receives the query image to generate the second set of feature maps (feature maps 424).

The RPR network generates 830 a set of global features based on the first set of feature maps and the second set of feature maps. In some embodiments, the RPR network includes a correlation network (e.g., correlation network 430). The correlation network includes a dot product module (e.g., dot product module 432), a first warp module (e.g., first warp module 440), a second warp module (e.g., second warp module 460), a positional encoder (e.g., positional encoder 450) and a concatenate module (e.g., concatenate module 462). The dot product module 432 is configured to receive the first set of feature maps 422 and the second set of feature maps to generate a correlation volume 434.

In some embodiments, the correlation volume is a 4D correlation volume computed to mimic soft feature matching. The correlation volume 434 is then used to warp the second set of feature maps 424 volume and a regular grid of coordinates (generated by the positional encoder 450). As illustrated, the first warp module is configured to warp the second set of feature map using the correlation volume. The second warp module is configured to warp positional data generated by the positional encoder using the correlation volume. The concatenate module is configured to concatenate the warped second feature map and positional data (e.g., grid of coordinates) to generate the set of global features.

The RPR network generates 840 a global feature vector based on the set of global features. In some embodiments, the RPR network includes a residual module (e.g., residual module 470) configured to receive the set of global feature to generate the global vector. The RPR network determines 850 a relative pose of the query camera relative to the reference camera based on the set of global features. In some embodiments, the RPR network includes a MLP module (MLP module 480) configured to receive the global vector to generate a relative pose.

FIG. 9 is a flowchart for a method 900 of determining a relative pose of a camera of a user relative to a reference camera using feature matching. Alterative embodiments may include more, fewer, or different steps from those illustrated in FIG. 9, and the steps may be performed in a different order from that illustrated in FIG. 9. These steps may be performed by a computer system, an online system, or a client device, such as a mobile phone, a camera, etc.

A system generates 910 a first depth map based on a reference image taken by a reference camera. The system generates 920 a second depth map based on a query image taken by a camera of a user. The system determines 930 correspondences between the first depth map and the second depth map. Referring to FIG. 3A, the left side is an example of a first depth map generated based on a reference image, the right side is an example of a second depth map generated based on a query image, and the dots on the left side and right side are the correspondence identified between the first depth map and the second depth map.

The system determines 940 a relative pose of the camera of the user relative to the reference camera based in part on the correspondences between the first depth map and the second depth map.

In some embodiments, intrinsics of cameras that took the reference image and the query image are also obtained and used to determine the pose of the query image. Assuming intrinsics of both images are known, as they are generally reported by modern devices. The absolute pose of a query image Q is parameterized by R SO(3), t R3, which maps a world point y to point x in the camera's local coordinate system as x=Ry+t. Assuming the global coordinate system is anchored to the reference image, the problem of estimating the absolute pose of the query becomes one of estimating a scaled relative pose between two images.

### Example Location-Based Parallel Reality Game

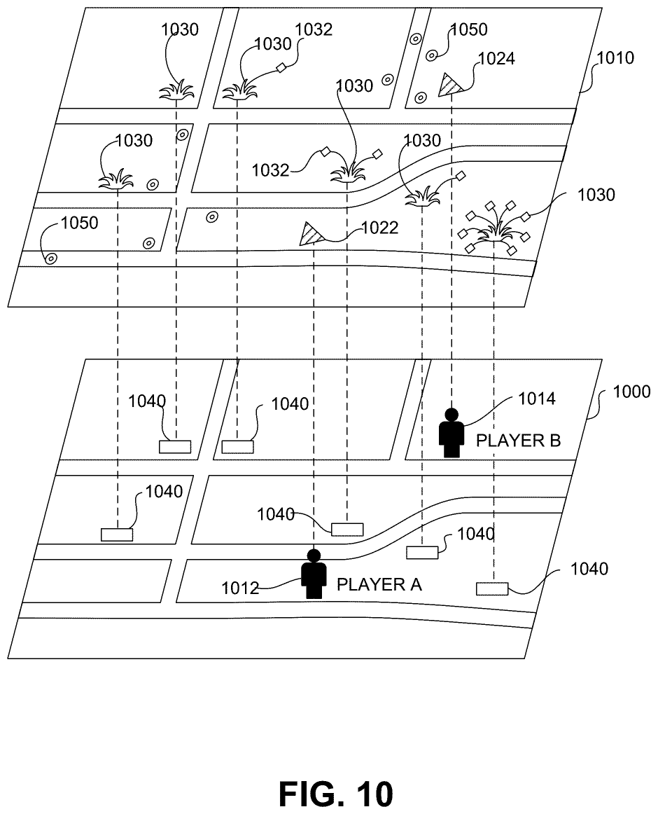

FIG. 10 is a conceptual diagram of a virtual world 1010 that parallels the real world 1000. The virtual world 1010 can act as the game board for players of a parallel reality game. As illustrated, the virtual world 1010 includes a geography that parallels the geography of the real world 1000. In particular, a range of coordinates defining a geographic area or space in the real world 1000 is mapped to a corresponding range of coordinates defining a virtual space in the virtual world 1010. The range of coordinates in the real world 1000 can be associated with a town, neighborhood, city, campus, locale, a country, continent, the entire globe, or other geographic area. Each geographic coordinate in the range of geographic coordinates is mapped to a corresponding coordinate in a virtual space in the virtual world 1010.

A player's position in the virtual world 1010 corresponds to the player's position in the real world 1000. For instance, player A 1012 located at a position in the real world 1000 has a corresponding position 1022 in the virtual world 1010. Similarly, player B located at position 1014 in the real world 1000 has a corresponding position 1024 in the virtual world 1010. As the players move about in a range of geographic coordinates in the real world 1000, the players also move about in the range of coordinates defining the virtual space in the virtual world 1010. In particular, a positioning system (e.g., a GPS system) associated with a mobile computing device carried by the player can be used to track a player's position as the player navigates the range of geographic coordinates in the real world 1000. Data associated with the player's position in the real world 1000 is used to update the player's position in the corresponding range of coordinates defining the virtual space in the virtual world 1010. In this manner, players can navigate along a continuous track in the range of coordinates defining the virtual space in the virtual world 1010 by simply traveling among the corresponding range of geographic coordinates in the real world 1000 without having to check in or periodically update location information at specific discrete locations in the real world 1000.

The location-based game can include game objectives requiring players to travel to or interact with various virtual elements or virtual objects scattered at various virtual locations in the virtual world 1010. A player can travel to these virtual locations by traveling to the corresponding location of the virtual elements or objects in the real world 1000. For instance, a positioning system can track the position of the player such that as the player navigates the real world 1000, the player also navigates the parallel virtual world 1010. The player can then interact with various virtual elements and objects at the specific location to achieve or perform one or more game objectives.

A game objective may have players interacting with virtual elements 1030 located at various virtual locations in the virtual world 1010. If the reference pose is unknown, the identity pose can be used. These virtual elements 1030 can be linked to landmarks, geographic locations, or objects 1040 in the real world 1000. The real-world landmarks or objects 1040 can be works of art, monuments, buildings, businesses, libraries, museums, or other suitable real-world landmarks or objects. Interactions include capturing, claiming ownership of, using some virtual item, spending some virtual currency, etc. To capture these virtual elements 1030, a player travels to the landmark or geographic locations 1040 linked to the virtual elements 1030 in the real world and performs any necessary interactions (as defined by the game's rules) with the virtual elements 1030 in the virtual world 1010. For example, player A 1012 may have to travel to a landmark 1040 in the real world 1000 to interact with or capture a virtual element 1030 linked with that particular landmark 1040. The interaction with the virtual element 1030 can require action in the real world, such as taking a photograph or verifying, obtaining, or capturing other information about the landmark or object 1040 associated with the virtual element 1030.

Game objectives may require that players use one or more virtual items that are collected by the players in the location-based game. The system may also determine a confidence value for its pose prediction. If the confidence value is below a threshold, the system returns no pose estimate. For instance, the players may travel the virtual world 1010 seeking virtual items 1032 (e.g. weapons, creatures, power ups, or other items) that can be useful for completing game objectives. These virtual items 1032 can be found or collected by traveling to different locations in the real world 1000 or by completing various actions in either the virtual world 1010 or the real world 1000 (such as interacting with virtual elements 1030, battling non-player characters or other players, or completing quests, etc.). In the example shown in FIG. 10, a player uses virtual items 1032 to capture one or more virtual elements 1030. In particular, a player can deploy virtual items 1032 at locations in the virtual world 1010 near to or within the virtual elements 1030. Deploying one or more virtual items 1032 in this manner can result in the capture of the virtual element 1030 for the player or for the team/faction of the player.

In one particular implementation, a player may have to gather virtual energy as part of the parallel reality game. Virtual energy 1050 can be scattered at different locations in the virtual world 1010. A player can collect the virtual energy 1050 by traveling to (or within a threshold distance of) the location in the real world 1000 that corresponds to the location of the virtual energy in the virtual world 1010. The virtual energy 1050 can be used to power virtual items or perform various game objectives in the game. A player that loses all virtual energy 1050 may be disconnected from the game or prevented from playing for a certain amount of time or until they have collected additional virtual energy 1050.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

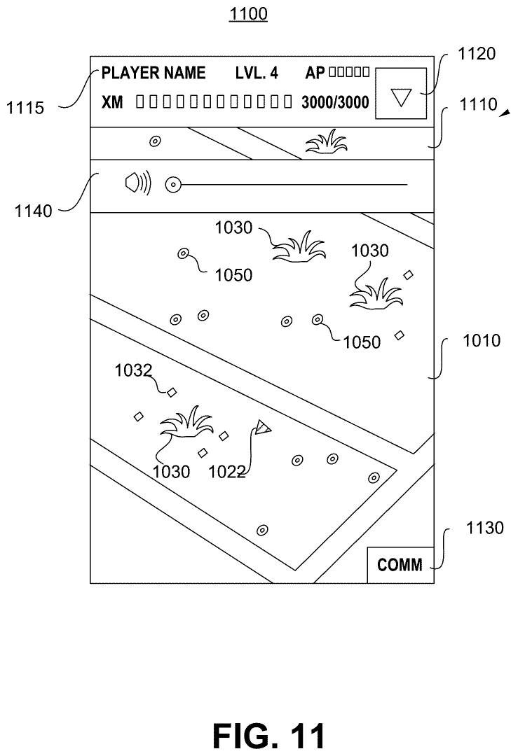

FIG. 11 depicts one embodiment of a game interface 1100 that can be presented (e.g., on a player's smartphone) as part of the interface between the player and the virtual world 1010. The game interface 1100 includes a display window 1110 that can be used to display the virtual world 1010 and various other aspects of the game, such as player position 1022 and the locations of virtual elements 1030, virtual items 1032, and virtual energy 1050 in the virtual world 1010. The user interface 1100 can also display other information, such as game data information, game communications, player information, client location verification instructions and other information associated with the game. For example, the user interface can display player information 1115, such as player name, experience level, and other information. The user interface 1100 can include a menu 1120 for accessing various game settings and other information associated with the game. The user interface 1100 can also include a communications interface 1130 that enables communications between the game system and the player and between one or more players of the parallel reality game.

According to aspects of the present disclosure, a player can interact with the parallel reality game by carrying a client device 1210 around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 1100 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 1140. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

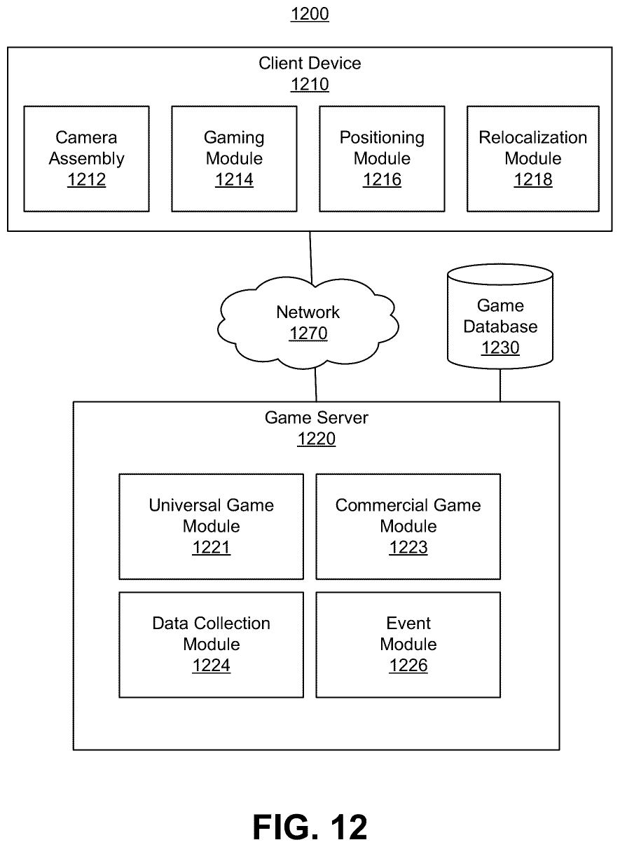

FIG. 12 illustrates one embodiment of a networked computing system 1200. The networked computing system 1200 uses a client-server architecture, where a game server 1220 communicates with a client device 1210 over a network 1270 to provide a parallel reality game to a player at the client device 1210. The networked computing system 1200 also may include other external systems such as sponsor/advertiser systems or business systems. Although only one client device 1210 is shown in FIG. 12, any number of client devices 1210 or other external systems may be connected to the game server 1220 over the network 1270. Furthermore, the networked computing system 1200 may contain different or additional elements and functionality may be distributed between the client device 1210 and the server 1220 in different manners than described below.

The networked computing system 1200 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 1210 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 1210.

A client device 1210 can be any portable computing device capable for use by a player to interface with the game server 1220. For instance, a client device 1210 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 1210 may be a less-mobile device such as a desktop or a laptop computer. Furthermore, the client device 1210 may be a vehicle with a built-in computing device.

The client device 1210 communicates with the game server 1220 to provide sensory data of a physical environment. In one embodiment, the client device 1210 includes a camera assembly 1212, a gaming module 1214, positioning module 1216, and relocalization module 1218. The client device 1210 also includes a network interface (not shown) for providing communications over the network 1270. In various embodiments, the client device 1210 may include different or additional components, such as additional sensors, display, and software modules, etc.

The camera assembly 1212 includes one or more cameras which can capture image data. The cameras capture image data describing a scene of the environment surrounding the client device 1210 with a particular pose (the location and orientation of the camera within the environment). The camera assembly 1212 may use a variety of photo sensors with varying color capture ranges and varying capture rates. Similarly, the camera assembly 1212 may include cameras with a range of different lenses, such as a wide-angle lens or a telephoto lens. The camera assembly 1212 may be configured to capture single images or multiple images as frames of a video.

The client device 1210 may also include additional sensors for collecting data regarding the environment surrounding the client device, such as movement sensors, accelerometers, gyroscopes, barometers, thermometers, light sensors, microphones, etc. The image data captured by the camera assembly 1212 can be appended with metadata describing other information about the image data, such as additional sensory data (e.g. temperature, brightness of environment, air pressure, location, pose etc.) or capture data (e.g. exposure length, shutter speed, focal length, capture time, etc.).

The gaming module 1214 provides a player with an interface to participate in the parallel reality game. The game server 1220 transmits game data over the network 1270 to the client device 1210 for use by the gaming module 1214 to provide a local version of the game to a player at locations remote from the game server. In one embodiment, the gaming module 1214 presents a user interface on a display of the client device 1210 that depicts a virtual world (e.g. renders imagery of the virtual world) and allows a user to interact with the virtual world to perform various game objectives. In some embodiments, the gaming module 1214 presents images of the real world (e.g., captured by the camera assembly 1212) augmented with virtual elements from the parallel reality game. In these embodiments, the gaming module 1214 may generate or adjust virtual content according to other information received from other components of the client device 1210. For example, the gaming module 1214 may adjust a virtual object to be displayed on the user interface according to a depth map of the scene captured in the image data.

The gaming module 1214 can also control various other outputs to allow a player to interact with the game without requiring the player to view a display screen. For instance, the gaming module 1214 can control various audio, vibratory, or other notifications that allow the player to play the game without looking at the display screen.

The positioning module 1216 can be any device or circuitry for determining the position of the client device 1210. For example, the positioning module 1216 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 1210 in the real world, the positioning module 1216 tracks the position of the player and provides the player position information to the gaming module 1214. The gaming module 1214 updates the player position in the virtual world associated with the game based on the actual position of the player in the real world. Thus, a player can interact with the virtual world simply by carrying or transporting the client device 1210 in the real world. In particular, the location of the player in the virtual world can correspond to the location of the player in the real world. The gaming module 1214 can provide player position information to the game server 1220 over the network 1270. In response, the game server 1220 may enact various techniques to verify the location of the client device 1210 to prevent cheaters from spoofing their locations. It should be understood that location information associated with a player is utilized only if permission is granted after the player has been notified that location information of the player is to be accessed and how the location information is to be utilized in the context of the game (e.g. to update player position in the virtual world). In addition, any location information associated with players is stored and maintained in a manner to protect player privacy.

In contrast to the positioning module 1216, which determine geographic coordinates of the client device 1210, the relocalization module 1218 determines the pose of one or more cameras of the camera assembly 1212 within the client device's immediate environment. In one embodiment, the relocalization module 1218 receives a single image of the environment of the client device 1210 and uses that single image as a reference image. In other embodiments, the relocalization module 1218 may receive multiple images (e.g., a set of five or ten images) of the environment to use as reference images.

The localization module 1218 applies a trained model to determine a depth map of the reference image(s). Thus, the localization module 1218 generates a 3D representation of the depicted scene within the environment from the reference image. The localization module 1218 then determines a current pose of a camera of the client device 1210 by comparing a current query image (or images) captured by the camera to the reference image(s) and corresponding depth map(s) without the need for a pre-determined 3D map of the environment. Additionally or alternatively, the pose of cameras of other client devices 1210 may be determined using the reference image(s) and depth map(s). For example, the relative position of two client devices engaged in a mutual AR session may be determined and used in gameplay (e.g., to determine if a ball thrown by one player hits another player). Various embodiments of the localization module 1218 and additional details of providing map-free relocalization are described in Appendix A. It should be understood that Appendix A describes specific embodiments and any feature described as or implied to be essential need only be present in the described embodiment and is not necessarily included in other embodiments.

The game server 1220 includes one or more computing devices that provide game functionality to the client device 1210. The game server 1220 can include or be in communication with a game database 1230. The game database 1230 stores game data used in the parallel reality game to be served or provided to the client device 1210 over the network 1270.

The game data stored in the game database 1230 can include: (1) data associated with the virtual world in the parallel reality game (e.g. imagery data used to render the virtual world on a display device, geographic coordinates of locations in the virtual world, etc.); (2) data associated with players of the parallel reality game (e.g. player profiles including but not limited to player information, player experience level, player currency, current player positions in the virtual world/real world, player energy level, player preferences, team information, faction information, etc.); (3) data associated with game objectives (e.g. data associated with current game objectives, status of game objectives, past game objectives, future game objectives, desired game objectives, etc.); (4) data associated with virtual elements in the virtual world (e.g. positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g. location of real-world objects/landmarks, description of real-world objects/landmarks, relevance of virtual elements linked to real-world objects, etc.); (6) game status (e.g. current number of players, current status of game objectives, player leaderboard, etc.); (7) data associated with player actions/input (e.g. current player positions, past player positions, player moves, player input, player queries, player communications, etc.); or (8) any other data used, related to, or obtained during implementation of the parallel reality game. The game data stored in the game database 1230 can be populated either offline or in real time by system administrators or by data received from users (e.g., players) of the system 1200, such as from a client device 1210 over the network 1270.

In one embodiment, the game server 1220 is configured to receive requests for game data from a client device 1210 (for instance via remote procedure calls (RPCs)) and to respond to those requests via the network 1270. The game server 1220 can encode game data in one or more data files and provide the data files to the client device 1210. In addition, the game server 1220 can be configured to receive game data (e.g. player positions, player actions, player input, etc.) from a client device 1210 via the network 1270. The client device 1210 can be configured to periodically send player input and other updates to the game server 1220, which the game server uses to update game data in the game database 1230 to reflect any and all changed conditions for the game.

In the embodiment shown in FIG. 12, the game server 1220 includes a universal gaming module 1222, a commercial game module 1223, a data collection module 1224, and an event module 1226. As mentioned above, the game server 1220 interacts with a game database 1230 that may be part of the game server or accessed remotely (e.g., the game database 1230 may be a distributed database accessed via the network 1270). In other embodiments, the game server 1220 contains different or additional elements. In addition, the functions may be distributed among the elements in a different manner than described.

The universal game module 1222 hosts an instance of the parallel reality game for a set of players (e.g., all players of the parallel reality game) and acts as the authoritative source for the current status of the parallel reality game for the set of players. As the host, the universal game module 1222 generates game content for presentation to players (e.g., via their respective client devices 1210). The universal game module 1222 may access the game database 1230 to retrieve or store game data when hosting the parallel reality game. The universal game module 1222 may also receive game data from client devices 1210 (e.g. depth information, player input, player position, player actions, landmark information, etc.) and incorporates the game data received into the overall parallel reality game for the entire set of players of the parallel reality game. The universal game module 1222 can also manage the delivery of game data to the client device 1210 over the network 1270. In some embodiments, the universal game module 1222 also governs security aspects of the interaction of the client device 1210 with the parallel reality game, such as securing connections between the client device and the game server 1220, establishing connections between various client devices, or verifying the location of the various client devices 1210 to prevent players cheating by spoofing their location.

The commercial game module 1223 can be separate from or a part of the universal game module 1222. The commercial game module 1223 can manage the inclusion of various game features within the parallel reality game that are linked with a commercial activity in the real world. For instance, the commercial game module 1223 can receive requests from external systems such as sponsors/advertisers, businesses, or other entities over the network 1270 to include game features linked with commercial activity in the real world. The commercial game module 1223 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 1224 can be separate from or a part of the universal game module 1222. The data collection module 1224 can manage the inclusion of various game features within the parallel reality game that are linked with a data collection activity in the real world. For instance, the data collection module 1224 can modify game data stored in the game database 1230 to include game features linked with data collection activity in the parallel reality game. The data collection module 1224 can also analyze and data collected by players pursuant to the data collection activity and provide the data for access by various platforms.

The event module 1226 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The network 1270 can be any type of communications network, such as a local area network (e.g. intranet), wide area network (e.g. Internet), or some combination thereof. The network can also include a direct connection between a client device 1210 and the game server 1220. In general, communication between the game server 1220 and a client device 1210 can be carried via a network interface using any type of wired or wireless connection, using a variety of communication protocols (e.g. TCP/IP, HTTP, SMTP, FTP), encodings or formats (e.g. HTML, XML, JSON), or protection schemes (e.g. VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Example Computing System

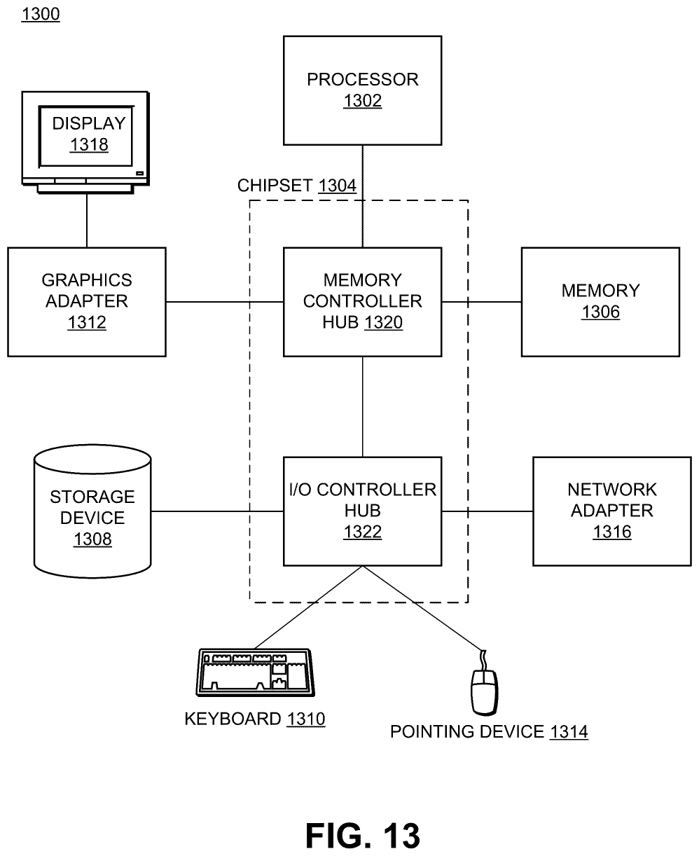

FIG. 13 is a block diagram of an example computer 1300 suitable for use as a client device 1210 or game server 1220. The example computer 1300 includes at least one processor 1302 coupled to a chipset 1304. The chipset 1304 includes a memory controller hub 1320 and an input/output (I/O) controller hub 1322. A memory 1306 and a graphics adapter 1312 are coupled to the memory controller hub 1320, and a display 1318 is coupled to the graphics adapter 1312. A storage device 1308, keyboard 1310, pointing device 1314, and network adapter 1316 are coupled to the I/O controller hub 1322. Other embodiments of the computer 1300 have different architectures.

In the embodiment shown in FIG. 13, the storage device 1308 is a non-transitory computer-readable storage medium such as a hard drive, compact disk read-only memory (CD-ROM), DVD, or a solid-state memory device. The memory 1306 holds instructions and data used by the processor 1302. The pointing device 1314 is a mouse, track ball, touch-screen, or other type of pointing device, and may be used in combination with the keyboard 1310 (which may be an on-screen keyboard) to input data into the computer system 1300. The graphics adapter 1312 displays images and other information on the display 1318. The network adapter 1316 couples the computer system 1300 to one or more computer networks, such as network 1270.

The types of computers used by the entities of FIG. 12 can vary depending upon the embodiment and the processing power required by the entity. For example, the game server 1220 might include multiple blade servers working together to provide the functionality described. Furthermore, the computers can lack some of the components described above, such as keyboards 1310, graphics adapters 1312, and displays 1318.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by any claims that ultimately issue.

What is claimed is:

1. A computer-implemented method for providing map-free relocalization of a device, the method comprising:
obtaining a reference image of an environment captured by a reference camera at a reference pose;
receiving a query image taken by a camera of the device;
applying the reference image and the query image to a relative pose regression network to output a relative pose of the camera of the device relative to the reference camera in the environment, the relative pose regression network comprising:
a Siamese network configured to receive the reference image to generate a first set of feature maps, and receive the query image to generate a second set of feature maps;
a correlation network configured to receive the first set of feature maps and the second set of feature maps as input to generate a set of global features;
a residual network configured to receive the set of global features as input to generate a global feature vector; and
a multilayer perceptron network configured to receive the global feature vector as input to determine the relative pose of the camera of the device relative to the reference camera in the environment; and
determining a pose of the camera of the device based on the relative pose of the camera of the device and the reference pose of the reference camera.

2. The method of claim 1, wherein the relative pose is a first relative pose indicating a pose of the camera of the device relative to the reference camera, the method comprising:
applying the query image and the reference image to the relative pose regression network to generate a second relative pose indicating a pose of the reference camera relative to the camera of the device;
determining a third relative pose indicating a pose of the camera of the device relative to the reference camera based on the second relative pose; and
determining an updated relative pose based on the first relative pose and the third relative pose.

3. The method of claim 1, wherein Siamese network comprises a first deep residual UNET and a second deep residual UNET, each of which is configured to receive the reference image or the query image:

4. The method of claim 1, wherein the relative pose regression network further comprising:
a second multilayer perceptron network configured to receive the global feature vector as input to generate an angular error indicating a confidence level of the determined relative pose.

5. The method of claim 4, wherein the angular error is determined with respect to a ground truth relative pose.

6. The method of claim 4, wherein second multiplayer perceptron network is trained based on a soft clamping function, describing a ground truth error and a network prediction.

7. The method of claim 1, wherein the correlation network is configured to compute a 4-dimensional correlation volume to mimic soft feature matching.

8. The method of claim 7, wherein the correlation network is further configured to use the 4-dimensional correlation volume to warp the second set of feature maps and a regular grid of coordinates.

9. The method of claim 8, wherein the correlation network is further configured to concatenate the warped second set of feature maps and the warped regular grid of coordinates to generate the set of global features.

10. The method of claim 8, wherein the relative pose regression network parameterizes rotations as a plurality of discrete angles.

11. The method of claim 8, wherein the relative pose regression network is trained via a training dataset comprising a plurality of pairs of training images, each pair of training images are taken in a same environment.

12. The method of claim 11, wherein each training image is associated with an absolute pose.

13. The method of claim 11, wherein each pair of training images is associated with an overlap score, indicating a level of overlapping between the pair of training images.

14. The method of claim 11, wherein each training image is associated with camera intrinsics describing information associated with a camera that took the training image.

15. The method of claim 11, wherein each training image is anonymized by detecting and blurring personally identifiable information on the training image.

16. A computer-implemented method for providing map-free relocalization of a device, the method comprising:
obtaining a reference image of an environment captured by a reference camera, wherein the reference image associated with a pose of the reference camera in the environment;
capturing a query image of the environment by a camera of the device;
generating a first depth map of the reference image;
generating a second depth map of the query image;
determining depth correspondences between the first depth map and the second depth map;
determining a pose of the camera of the device based in part on the depth correspondences between the first depth map and the second depth map.

17. The method of claim 16, the method further comprising:
determining 2-dimensional to 2-dimensional (2D-2D) correspondences between 2-dimensional points on the query image and 2-dimensional points on the reference image; and
determining the pose of the camera of the device further based on 2D-2D correspondences.

18. The method of claim 16, the method further comprising:
back-projecting one of first depth map or second depth map to a 3-dimensional image;
determining 2-dimensional to 3-dimensional (2D-3D) correspondences between the query image or the reference image and the 3-dimensional image;
determining a pose of the camera of the device further based on the 2D-3D correspondences.

19. The method of claim 16, the method further comprising:
back-projecting the reference image to a first 3-dimensional image based on the first depth map;
back-projecting the query image to a second 3-dimensional image based on the second depth map;
determining 3-dimensional to 3-dimensional (3D-3D) correspondences between 3-dimensional points on the first 3-dimensional image and 3-dimensional points on the second 3-dimensional image, wherein each 3D-3D correspondence provides a scale estimate for a translation vector; and
determining a pose of the camera of the device further based on the 3D-3D correspondences.

20. The method of claim 16, further comprising:
accessing a dataset comprising a plurality of reference images to obtain the reference image, each of the plurality of reference images is an image of a place of interest that is well captured by a single image.
